(19) United States
(12) Patent Application Publication
(10) Pub. No.: US 2003/0120614 A1
(43) Pub. Date: Jun. 26, 2003

(54) Automated e-commerce authentication method and system

(75) Inventor: James Michael Shumpert, Summit, NJ (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Dun & Bradstreet, Inc.

(21) Appl. No.: 10/027,658

(22) Filed: Dec. 20, 2001

(51) Int. Cl. G06F 17/60

(52) U.S. Cl. 705/76

(57) ABSTRACT

A computer system and method that authenticates a business partner fully automatically in response to a request from a user. The computer system is interconnected via network with a user device operated by the user and a partner device operated by the business partner. Identifying data of the business partner is provided on a standard template that has a data format that is compatible with the data handling capability of the computer system. The identifying data of the business partner is matched to a data record of a business entity contained in a business database. Selected data attributes of the data record are processed according to an authentication policy to determine authenticity.

### FIELD OF THE INVENTION

This invention relates to a method and system that authenticates a business partner.

### BACKGROUND OF THE INVENTION

Systems that are capable of finding a match for a given entity in a database containing information on a large number of entities are well known. For example, U.S. Pat. No. 5,659,731 describes a method and system that assigns grades or scores based on the quality of a match of data attributes. For instance, in the credit industry, credit history information on a given business entity being considered for credit is typically processed through a commercially available business database, such as a Dun & Bradstreet database. A user may input the name of a business entity into a processor connected to the database, which then locates that given entity in the database and retrieves its credit history information. The credit history information is then used to make a decision on whether to grant or withhold credit for the given entity.

Business entities are typically listed in a business database by what can be called attributes. The most common attributes are those that identify the entity, such as the business name and location. Location can be broken down into a number of attributes which include street number, street name, P.O. box number, city, town or the like, state (if in the U.S.) or country, and telephone number. These are common attributes, which are found in many commercial databases reporting information on business entities. Other attributes are, however, sometimes utilized.

Current methods for authenticating a business partner use an off-line technique that makes a request to authenticate a business partner either by mail, telephone, facsimile, the Internet, email and the like. The request also provides some data that identifies the business partner. However, the identifying data differs from one request to another due to different styles of expressing names, addresses, and other identifying data, as well as the care exercised by those collecting the identifying data. As a result, the identifying data is frequently manually entered into the computer system associated with the business database. The authentication process then employs a matching technique, such as that described in the aforementioned U.S. Pat. No. 5,659,731, to find a data record of a business in the business database that matches the identifying data of the business partner. The data record of the matched business is then assessed for authenticity. This procedure, though reliable, is rather slow compared to the speed required to satisfy the needs of a user who transacts business on the worldwide web, hereafter referred to as the “Web”.

Thus, there is a need for an automated method and system that can give an authenticity report in a rapid turn around time.

The present invention also provides many additional advantages, which shall become apparent as described below.

### SUMMARY OF THE INVENTION

The method of the present invention automatically authenticates a business partner in response to a request of a user. An identity of the business partner is provided. The identity of the business partner is matched to a business that is one of a plurality of businesses for which a data record is stored in a business database. One or more data attributes of the data record of the matched business are processed with an authentication policy that includes a set of rules to determine if the business partner is authentic. A report of the determination of authenticity is reported to the user. The steps of providing the identity, matching, processing and notifying are performed automatically by a computer system associated with the business database alone or in combination with a user device operated by the user via a network.

According to one aspect of the method, a standard template for entry of data for the identity of the business partner is provided. The standard template has a data format that is compatible with the computer system. The standard template is presented to either the user or the business partner for completion.

According to another aspect of the method of the invention, the authentication policy includes an authenticity rule that requires the business partner to have current transactions with trade references.

According to another aspect of the method, if no match is found for the identifying data of the business partner, a registration template is presented to the business partner for registration in the business database.

According to another aspect of the method, the business database is searched for a credential of the business partner. The credential, for example, is a license, purchase authority, bank account verification, professional memberships or industry memberships.

The computer system of the invention performs the method of the invention.

### BRIEF DESCRIPTION OF THE DRAWING

Other and further objects, advantages and features of the present invention will be understood by reference to the following specification in conjunction with the annexed drawings, wherein like parts have been given like numbers; and

FIG. 1 is a block diagram of a system that uses the present invention;

FIG. 2 is a block diagram of the computer system of FIG. 1; and

FIG. 3 is a flow diagram of the authentication program of the computer system in FIG. 2.

### DESCRIPTION OF THE PREFERRED EMBODIMENTS

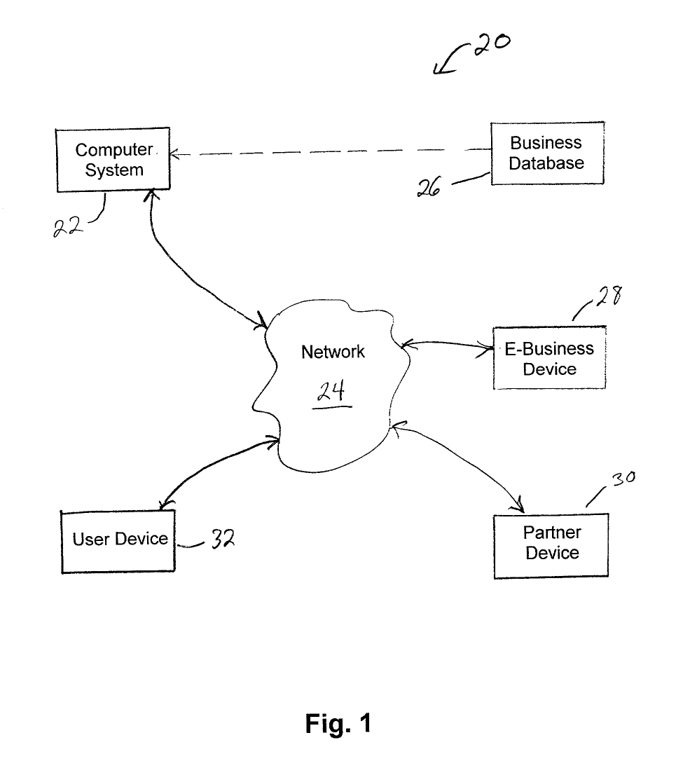

Referring to FIG. 1, a communication system 20 includes a computer system 22, a network 24, a business database 26, an e-business device 28, a partner device 30 and a user device 32. Network 24 interconnects computer system 22, e-business device 28, partner device 30 and user device 28. Business database 26 is directly connected to computer system 22, but could also be so interconnected via network 24.

Network 24 may be any wired or wireless communication network capable of conducting communications. For example, network 24 may be an Internet, an Intranet, the Web, a public telephone network, other networks and any combination thereof. Network communication capability, such as modems, browsers and/or server capability (not shown), is associated with each device interconnected with network 24.

User device 28 and partner device 30 may each be any suitable device upon which a browser may run, such as a personal computer, a telephone, a television set, a hand held computing device and the like. It will be appreciated by those skilled in the art that, though only one user device 32 is shown, a plurality of user devices are possible.

Computer system 22 may be any suitable computer, presently known or developed in the future, that is capable of communicating in a protocol that is compatible with the browser capabilities of partner device 30 and user device 32, and that is capable of running applications as described herein. Computer system 22 may be a single computer or may comprise a plurality of computers that are interconnected directly or via network 24.

The e-business device 30 may be any suitable computer, presently known or developed in the future, that is capable of communicating in a protocol that is compatible with the browser capabilities of partner device 30 and user device 32, and that is capable of running applications as described herein. The e-business device 28 may be a single computer or may comprise a plurality of computers that are interconnected directly or via network 24.

Database 26 includes a data framework for data concerning a plurality of businesses with each business being identified by a business identifier (id). For example, database 26 might include the data framework and business data of Dun & Bradstreet (D&B), which includes a plurality of corporate identifiers. Such corporate identifiers are preferably a DUNS number that identifies each business in the data framework.

Computer system 22 and business database 26 operate to provide via network 24 authentication data that is requested by a user operating user device 32. Business database 26 is referred to herein as a single database, by way of example, even though it may be a single database or a plurality of databases.

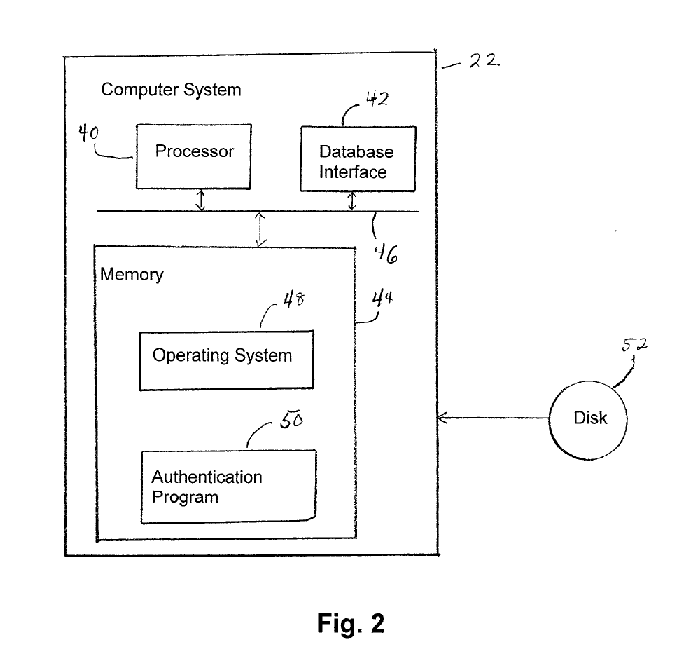

Referring to FIG. 2, computer system 22 includes a processor 40, a database interface unit 42 and a memory 44 that are interconnected via a bus 46. Memory 44 includes an operating system 48 and an authentication program 50. Other programs, such as utilities, browsers and other applications, may also be stored in memory 44. All of these programs may be loaded into memory 34 from a storage medium, such as a disk 52.

Processor 40 is operable under the control of operating system 48 to run authentication program 50 to respond to a request user device 32 to supply authentication data pertinent for a selected or target business. User device 32 is operated by a representative of a user company, hereafter referred to as “user”.

By way of example, the present invention will be described for the case, in which the business partner is XYZ Company, hereafter referred to as XYZ. The business relation between XYZ and user is that XYZ is a business partner of user, such as a supplier, customer, joint venture partner, licensee, licensor, or other business partner. In the example, the user operates user device 32 to request that XYZ be authenticated as a viable business partner. The request is made by user device 32 either directly to computer system 22 via network 24 or indirectly via e-business device 30. For example, e-business device 30 may supply various business services to the user, one of which may be an authentication service linked to computer system 22. In the example to be described, user device 32 will be assumed to directly communicate with computer system 22 via network 24.

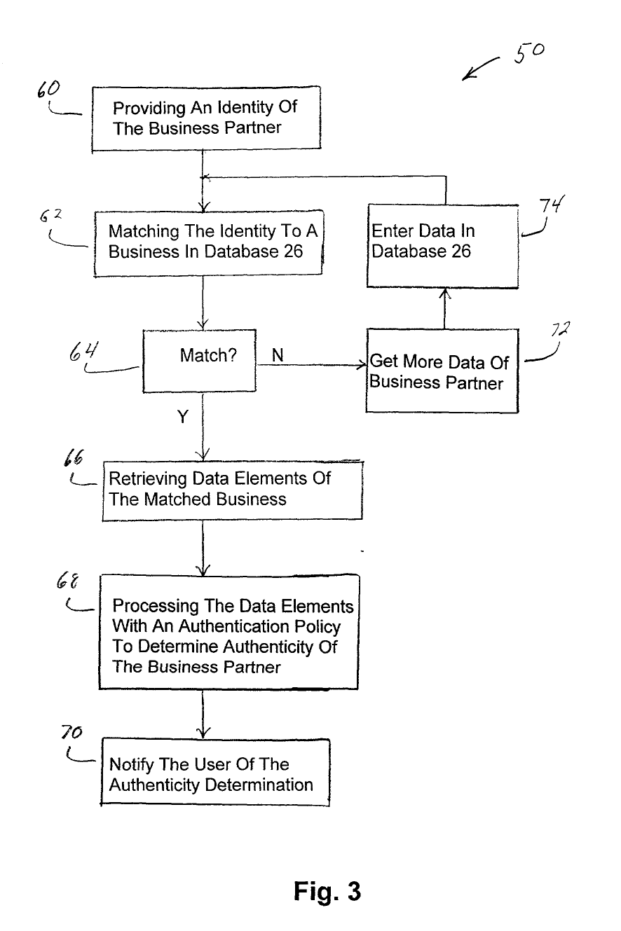

Referring to FIG. 3, authentication program 50 includes a step 60 that provides an identity of the business partner, XYZ. This step is accomplished by receiving from the user a request for authentication of XYZ and identifying data thereof. In one aspect of the present invention, user device 32 notifies computer system 22 of the request and computer system 22 presents an identification template to partner device 30 for completion by XYZ and subsequent return to computer system 22. In a preferred embodiment, the identification template is presented as a web page to partner device 30. When XYZ has completed the template, clicking on a button can notify computer system 22 that the template is completed and the data can be captured by computer system 22.

In another embodiment, the identification template can be cached at user device 32 for presentation to partner device 30. When the template is completed by XYZ, the template can be noticed directly to computer system 22. For example, a completion button can be hot linked to a web site of computer system 22. Alternatively, the completed template can be noticed to computer system 22 by user device 32 either by posting to a web site of or by email to computer system 22.

By designing the template in a form compatible with computer system 22, the identifying data of XYZ can be used without transformation by computer system 22 to access database 26. The identifying data includes at least the following attributes of the business partner: business name, business address and business telephone. Also, other identifying data may be given, such as email address, web site address, facsimile number and the like.

Step 62 matches the identifying data to a data record of a business in database 26. That is, step 62 searches database 26 for a data record of a business that contains attributes that match those of the identifying data of XYZ. If a match is found, step 66 retrieves certain data elements or attributes of the matched business data records. These data attributes are those that will be needed by an authentication process. Step 68 then processes the retrieved data elements in accord with the authentication policy that includes a plurality of authentication rules to determine authenticity of the target business.

The authentication policy can have a multiplicity of different rules or policies for determining authenticity. By way of example, one rule that can be used is to check trade references of XYZ. These trade references can be found either in the data record of the matched business or can be obtained from XYZ. The trade references are checked for current transactions involving XYZ. If current transactions are found, there is a high probability that XYZ is authentic. If no current transactions are found, XYZ is probably not authentic. Step 70 notifies user device 32 of the determination made by step 70.

If step 64 determines that no match is found by step 62, step 72 gets more data related to XYZ. This is accomplished either by computer system 22 or user device 32 notifying partner device 30 that more data is needed for the authentication procedure. The notice can include a more detailed template, e.g., a template for registration of a business for inclusion in business database 26. When the additional data is obtained, step 74 enters the data into database 26 and assigns DUNS number thereto. Steps 62 and 64 are then repeated and steps 66 through 70 are performed.

Another aspect of the present invention is that the user can specify that additional attributes or credentials of the business partner be considered. These credentials may be positive, such as professional licenses, purchasing authority, bank account verification, professional/industry memberships, and the like. Some of the credentials may be negative, such as bankruptcy, indicators of fraud, government debarment, and the like.

Steps 62, 64 and 66 search for the credentials in database 26 or other databases. If not found, step 72 can be used to directly request XYZ to furnish the credential data. Step 68 then considers the found credential data and provides a report, which is noticed, to the user by step 70. The notice can be communicated by posting to a web page or site, email, or other notice facility.

While I have shown and described several embodiments in accordance with my invention, it is to be clearly understood that the same are susceptible to numerous changes apparent to one skilled in the art. Therefore, I do not wish to be limited to the details shown and described but intend to show all changes and modifications, which come, within the scope of the appended claims.

What is claimed is:

1. A method for authenticating a business partner in response to a request of a user comprising:
(a) providing an identity of said business partner;
(b) matching said identity of said business partner to a business that is one of a plurality of businesses for which a data record is stored in a business database; and
(c) processing one or more data attributes of said data record with at least one business according to a set of authentication rules to determine if said business partner is authentic.

2. The method of claim 1, further comprising: notifying said user of the determination made by step (c), and wherein said notifying step and steps (a), (b) and (c) are automatically performed by a computer system either alone or in combination with a user device via a network.

3. The method of claim 1, further comprising: providing a standard template for entry of data for said identity of said business partner, wherein a data format of said template is compatible with a computer system that performs steps (a) and (b).

4. The method of claim 3, wherein said standard template is presented to said user for completion.

5. The method of claim 3, wherein said standard template is presented to said business partner for completion.

6. The method of claim 1, wherein said authentication rules require one or more current transactions with trade references.

7. The method of claim 1, further comprising: if step (b) fails to find a match, presenting a registration template to said business partner for registration in said business database.

8. The method of claim 1, further comprising: searching said business database for a credential of said business partner.

9. The method of claim 8, wherein said credential is selected from the group consisting of: license, purchase authority, bank account verification, professional memberships and industry memberships.

10. A computer system for authenticating a business partner in response to a request of a user comprising:
means for providing an identity of said business partner;
matching means for matching said identity of said business partner to a business that is one of a plurality of businesses for which a data record is stored in a business database; and
processing means for processing one or more data attributes of said data record with at least one business according to a set of authentication rules to determine if said business partner is authentic.

11. The computer system of claim 10, further comprising: notifying means for notifying said user of the determination made by said processing means.

12. The computer system of claim 10, further comprising: template providing means for providing a standard template for entry of data for said identity of said business partner, wherein a data format of said template is compatible with a data handling capability of said means for proving and said matching means.

13. The computer system of claim 12, wherein said standard template is presented to said user for completion.

14. The computer system of claim 12, wherein said standard template is presented to said business partner for completion.

15. The computer system of claim 10, wherein said authentication rules require one or more current transactions with trade references.

16. The computer system of claim 10, further comprising: if said matching means fails to find a match, presenting a registration template to said business partner for registration in said business database.

17. The computer system of claim 10, further comprising: means for searching said business database for a credential of said business partner.

18. The computer system of claim 10, wherein said credential is selected from the group consisting of: license, purchase authority, bank account verification, professional memberships and industry memberships.
